(19) United States
(12) Patent Application Publication
(10) Pub. No.: US 2009/0258179 A1
(43) Pub. Date: Oct. 15, 2009

(54) Decorative rug/mat cover

(76) Inventors: Lucia Sudol, Pompton Plains, NJ (US); Daniel J. Sudol, Pompton Plains, NJ (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/081,031

(22) Filed: Apr. 9, 2008

(51) Int. Cl. B32B 3/04

(52) U.S. Cl. 428/68

(57) ABSTRACT

The decorative rug/mat cover is a changeable, washable cover designed to fit a small to medium mat or rug that may be found in a bathroom or kitchen. A hemmed pocket around the perimeter of the lower surface receives and retains the edges of a rug or mat, and has a large opening to take advantage of any textured material on the bottom of the rug or mat to prevent slippage. Horizontal retaining straps on the lower surface hold the rug/mat cover securely, and may be made from hook and loop fabric or elastic to allow the rug to lie flat. The decorative rug/mat cover may be made from a cotton or muslin type fabric and allows a user to change the cover easily for washing or for seasonal decorating changes.

### BACKGROUND OF THE INVENTION

1. Field of the Invention

The present invention relates to washable covers and wraps. More specifically, the invention relates to a decorative rug/mat cover that provides a washable wrap for rugs and mats that may be easily changed to exhibit various decorative patterns.

2. Description of the Related Art

A mat is a generic term for a piece of fabric or carpet material, generally placed on a floor or other flat surface and serving a wide range of purposes. Many mats or rugs are made from woven carpet-like material and are used wherever small floor surface coverage is desired, such as a bathroom or kitchen floor.

Carpets and rugs can be a major source of allergies, both new rugs that emit chemical odors, and old rugs that harbor allergens. For new rugs, the fabric, padding and adhesive emit volatile organic compounds and some people report symptoms such as upper respiratory irritations, headaches, skin rashes, shortness of breath and fatigue.

As far as old carpets and rugs are concerned, everything that touches the feet of a dog or cat or the bottom of a person's shoe is tracked in a deposited in the fibers. Additionally, fleas and insects can breed in the fibers of a rug or mat, along with dust mites that feed on animal dander or any other dead skin that finds its way into the rug fibers.

In addition to harboring allergens, rugs, especially bath mats, can have dangerous levels of bacteria and germs. Studies have shown that bathroom floors have higher levels of bacteria than even toilets or sinks. Health professional recommend that bath mats be washed at least weekly. Many bathroom mats have foam backing to prevent slipping, however, and the backing material on the mat often deteriorates quite rapidly with frequent machine washing and drying. This can be expensive and impractical for the average person.

An additional concern relative to mats and rugs is when a person might want to change the color of the rug in response to a new decorating scheme or to reflect a seasonal or holiday observance. There may not be a wide variety of colors and patterns available, and having a rug or mat that is used only a certain portion of the year, such as Christmas or Easter can be prohibitively expensive. There is a need, therefore, for a rug/mat cover that is inexpensive, easy to remove, durable, washable and can be made available in a wide variety of sizes, colors and patterns.

Thus, a decorative rug/mat cover solving the aforementioned problems is desired.

### SUMMARY OF THE INVENTION

The decorative rug/mat cover is a slipcover designed to fit a small to medium mat or rug, such as one might find in a bathroom or kitchen.

The decorative rug/mat cover has a hemmed pocket around the perimeter of the lower surface, adapted to securely receive and retain a rug or mat. The pocket fits around the perimeter of a rug or mat, and has a large opening to take advantage of the foam or textured material on the bottom of the rug or mat to prevent slippage. A horizontal retaining strap fastens across the lower surface, helping to keep the rug/mat cover in position on the rug or mat. The retaining strap may be made from a hook and loop material such as Velcro, and may be elastic to allow the rug or mat to lie flat.

The decorative rug/mat cover may be made from a lightweight fabric such as cotton or muslin. It can be removed easily for washing, and is inexpensive to manufacture. The decorative rug/mat cover may be offered in a wide variety of patterns, shapes and colors, and the low cost allows a user to change the covers for seasonal decorating or on personal whim.

These and other features of the present invention will become readily apparent upon further review of the following specification and drawings.

### BRIEF DESCRIPTION OF THE DRAWINGS

FIG. 1 is a bottom, perspective view of a decorative rug/mat cover according to the present invention.

FIG. 2 is a bottom, perspective view of an alternative embodiment of a decorative rug/mat cover according to the present invention configured for a larger rug.

FIG. 3 is a top, perspective view of a decorative rug/mat cover according to the present invention.

Similar reference characters denote corresponding features consistently throughout the attached drawings.

### DETAILED DESCRIPTION OF THE PREFERRED EMBODIMENT

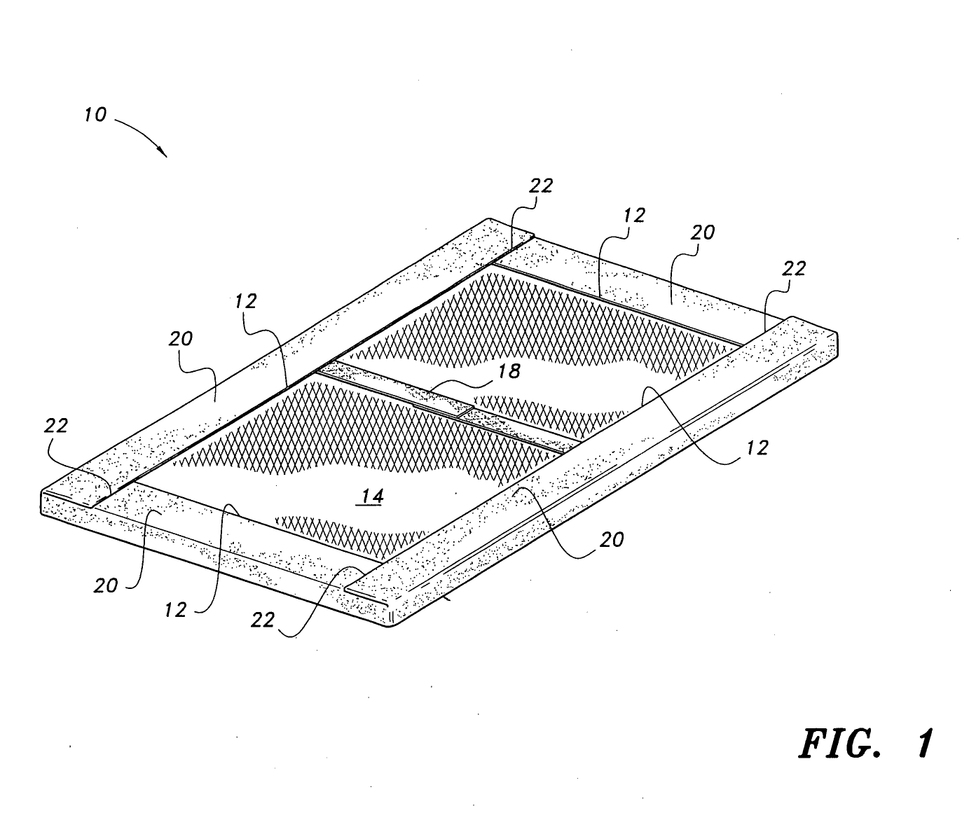

The present invention is decorative rug/mat cover shown in FIG. 1 in a perspective, bottom view and designated as 10. A pocket 20 extends around the perimeter of the cover 10 and is adapted for receiving and retaining a rug or mat 14. The pocket has a hemmed edge 12 all around the perimeter. A retaining strap 18 secures the rug/mat cover 10. The retaining strap 18 may be elastic to allow the rug to lie flat and made from hook and loop material. The seams 22 that secure the pocket 20 are sewn straight and parallel to the seams 22 on the opposite side. The pocket 20 is of uniform width around the perimeter, and a large space remains open to take advantage of any foam or textured backing on the rug or mat 14 to prevent slippage.

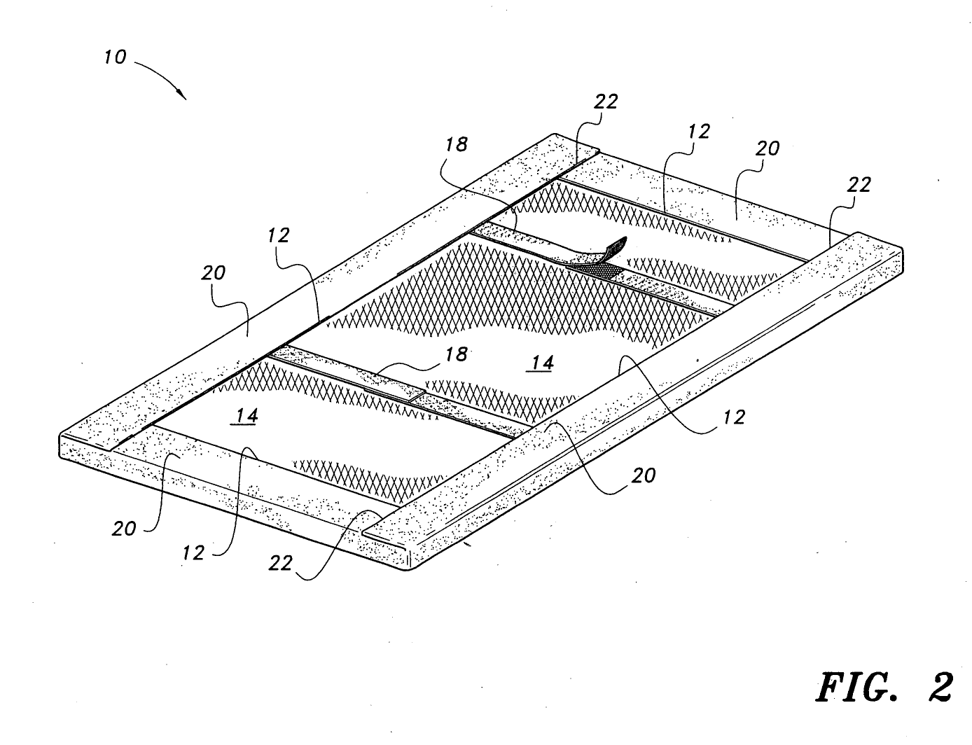

FIG. 2, shown from the same perspective as FIG. 1, shows an alternative embodiment of the decorative rug/mat cover that is configured for use with a larger rug, having two horizontal retaining straps 18.

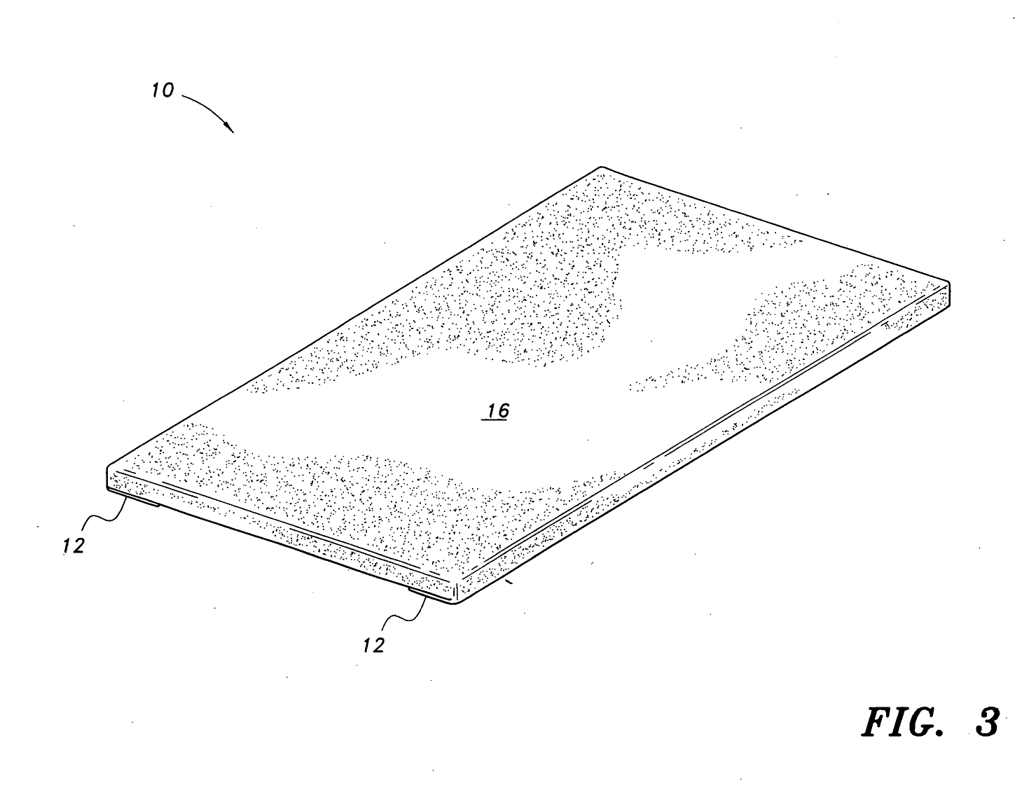

FIG. 3 is a perspective, top view of the decorative rug/mat cover 10. The upper surface 16 of the decorative rug/mat cover 10 is shown. The upper surface may contain any variety of design, pattern or color. The rug/mat cover is easily washable and removable.

It is to be understood that the present invention is not limited to the embodiment described above, but encompasses any and all embodiments within the scope of the following claims.

We claim:

1. A decorative cover for rugs and mats, comprising:
a substantially rectangular cover having an upper and lower surface, the cover having a hemmed edge folded against the lower surface and extending around the perimeter of the lower surface and defining a pocket for receiving and retaining the edges of a rug, carpet or mat; and
at least one retaining strap extending horizontally across the lower surface from the hemmed edge of the pocket to the opposing hemmed edge on the opposite side of the lower surface of the cover.

2. The decorative cover according to claim 1, wherein the corners of the pocket have seams sewn parallel to the seam on an opposing side of the lower surface.

3. The decorative cover according to claim 1, wherein the retaining strap is made of hook and loop material.

4. The decorative rug/mat cover according to claim 1, wherein the retaining strap is elastic.
